(19) United States
(12) Patent Application Publication
(10) Pub. No.: US 2014/0267959 A1
(43) Pub. Date: Sep. 18, 2014

(54) DISPLAY DEVICE AND ELECTRONIC APPARATUS

(71) Applicant: Japan Display Inc., Tokyo (JP)

(72) Inventor: Yingbao Yang, Tokyo (JP)

(73) Assignee: JAPAN DISPLAY INC., Tokyo (JP)

(21) Appl. No.: 14/208,539

(22) Filed: Mar. 13, 2014

(30) Foreign Application Priority Data
Mar. 14, 2013 (JP) 2013-052566

(51) Int. Cl. G02B 27/22

(52) U.S. Cl. CPC G02B 27/22
USPC 349/15

(57) ABSTRACT

According to an aspect, a display device includes: a display unit that displays either one of a two-dimensional image and a three-dimensional image; a liquid crystal unit that includes a plurality of electrodes used to drive a liquid crystal layer and is placed over the display unit; and a drive circuit that applies, when the display unit displays the three-dimensional image, voltages to the electrodes so that the liquid crystal layer forms either one of a lens and a barrier, and applies, when the display unit displays the two-dimensional image, a substantially fixed voltage to the electrodes.

### CROSS-REFERENCE TO RELATED APPLICATIONS

This application claims priority from Japanese Application No. 2013-052566, filed on Mar. 14, 2013, the contents of which are incorporated by reference herein in its entirety.

### BACKGROUND

1. Technical Field

The present disclosure relates to a display device and an electronic apparatus with the display device.

2. Description of the Related Art

A technology for securing a space between liquid crystal substrates by arranging spacers between the substrates is known (e.g., Japanese Patent Application Laid-open Publication No. 2012-173715).

However, by arranging spacers between liquid crystal substrates, the spacers may become visible from users. This may cause deterioration of visibility of a liquid crystal screen.

For the foregoing reasons, there is a need for a display device and an electronic apparatus capable of reducing the degradation of the visibility due to the presence of spacers.

### SUMMARY

According to an aspect, a display device includes: a display unit that displays either one of a two-dimensional image and a three-dimensional image; a liquid crystal unit that includes a plurality of electrodes used to drive a liquid crystal layer and is placed over the display unit; and a drive circuit that applies, when the display unit displays the three-dimensional image, voltages to the electrodes so that the liquid crystal layer forms either one of a lens and a barrier, and applies, when the display unit displays the two-dimensional image, a substantially fixed voltage to the electrodes.

According to another aspect, an electronic apparatus includes: a display unit that displays either one of a two-dimensional image and a three-dimensional image; a liquid crystal unit that includes a plurality of electrodes used to drive a liquid crystal layer and is placed over the display unit; and a drive circuit that applies, when the display unit displays the three-dimensional image, voltages to the electrodes so that the liquid crystal layer forms either one of a lens and a barrier, and applies, when the display unit displays the two-dimensional image, a substantially fixed voltage to the electrodes.

### BRIEF DESCRIPTION OF THE DRAWINGS

FIG. 1 is a schematic block diagram of a display device;

FIG. 2 is a perspective view of a display unit and a liquid crystal unit included in the display unit;

FIG. 3 is a schematic cross-sectional view of the display device;

FIG. 4 is a diagram of an example of control when a three-dimensional image is displayed;

FIG. 5 is a diagram of an example of light transmission when the display device in which a voltage is not applied to electrodes of the liquid crystal unit is viewed from the front;

FIG. 6 is a diagram of an example of light transmission when the display device in which a voltage is not applied to the electrodes of the liquid crystal unit is viewed obliquely;

FIG. 7 is a diagram of an example when the display device in which a voltage is not applied to the electrodes of the liquid crystal unit is viewed obliquely;

FIG. 8 is a diagram of an example of control when a two-dimensional image is displayed;

FIG. 9 is a diagram of an example when the display device displaying a two-dimensional image is viewed obliquely;

FIG. 10 is a flowchart of an operation of a drive circuit;

FIG. 11 is a diagram of an example of an electronic apparatus with the display device according to the embodiment;

FIG. 12 is a diagram of an example of an electronic apparatus with the display device according to the embodiment;

FIG. 13 is a diagram of an example of an electronic apparatus with the display device according to the embodiment;

FIG. 14 is a diagram of an example of an electronic apparatus with the display device according to the embodiment;

FIG. 15 is a diagram of an example of an electronic apparatus with the display device according to the embodiment;

FIG. 16 is a diagram of an example of an electronic apparatus with the display device according to the embodiment;

FIG. 17 is a diagram of an example of an electronic apparatus with the display device according to the embodiment;

FIG. 18 is a diagram of an example of an electronic apparatus with the display device according to the embodiment;

FIG. 19 is a diagram of an example of an electronic apparatus with the display device according to the embodiment;

FIG. 20 is a diagram of an example of an electronic apparatus with the display device according to the embodiment;

FIG. 21 is a diagram of an example of an electronic apparatus with the display device according to the embodiment;

FIG. 22 is a diagram of an example of an electronic apparatus with the display device according to the embodiment; and

FIG. 23 is a diagram of an example of an electronic apparatus with the display device according to the embodiment.

### DETAILED DESCRIPTION

Exemplary embodiments of the present disclosure will be explained in detail below with reference to the accompanying drawings. The explanation is performed in the following order.

1. Configuration of Display Device

2. Control of Display Device

3. Application Examples (Electronic Apparatuses)

4. Aspects of the present disclosure

### 1. Configuration of Display Device

FIG. 1 is a schematic block diagram of a display device. FIG. 2 is a perspective view of a display unit and a liquid crystal unit included in the display unit. FIG. 3 is a schematic cross-sectional view of the display device.

A display device 1 illustrated in FIG. 1 to FIG. 3 can display a two-dimensional (2D) image and a three- dimensional (3D) image. The 2D image is formed so that the same image is seen by user's right eye and left eye. The 3D image is formed so that an image for the right eye and an image for the left eye created so as to be seen stereoscopically by using parallax are seen by the user's right eye and left eye respectively.

As illustrated in FIG. 1, the display device 1 includes a liquid crystal unit 10, a display unit 20, and a drive circuit 40. The display unit 20 displays a 2D image and a 3D image. Examples of the display unit 20 include, but are not limited to, a liquid-crystal display device, an organic electro-luminescence (OEL) display device, a plasma display device, and an electronic paper. In the following, for the sake of simplicity of explanation, the display unit 20 is assumed to be a liquid-crystal display device.

As illustrated in FIG. 3, the display unit 20 includes a liquid crystal layer 21, a substrate 22, a polarizer 23, a circuit 24, color filters 25, and electrodes 26. The liquid crystal layer 21 contains liquid crystal molecules 21a. The substrate 22 is, for example, a glass substrate. The polarizer 23 is used to switch between transmission and non-transmission of light in combination with control of the liquid crystal molecules 21a. The circuit 24 has switching elements being transistors or the like such as thin film transistors (TFTs) formed in a matrix in order to control the liquid crystal molecules 21a corresponding to respective pixels, and also has pixel electrodes electrically coupled to the switching elements. The color filter 25 transmits light of a predetermined color for each sub-pixel.

In the display unit 20 illustrated in FIG. 3, the liquid crystal layer 21 containing the liquid crystal molecules 21a is driven by an electric field generated between the pixel electrodes and the electrodes 26. In this way, the drive system using the electric field vertically generated between the substrates includes a vertical electric field mode such as a twisted nematic (TN) mode and a vertical alignment (VA) mode. However, the drive system of the liquid crystal layer 21 is not limited to the vertical electric field mode, and therefore a horizontal electric field mode may be used. In the display unit 20 in the horizontal electric field mode, the electrodes 26 are provided on the substrate 22. The horizontal electric field mode includes an in-plane switching (IPS) mode and a fringe field switching (FFS) mode, and the like.

As illustrated in FIG. 2, the liquid crystal unit 10 is placed over the display unit 20. When the display unit 20 displays a 3D image, the liquid crystal unit 10 forms a liquid crystal lens or a liquid crystal barrier so that an image for the right eye is seen by the user's right eye and an image for the left eye is seen by the user's left eye. In the following, for the sake of simplicity of explanation, it is assumed that the liquid crystal lens is formed when the display unit 20 displays a 3D image.

As illustrated in FIG. 3, the liquid crystal unit 10 includes a liquid crystal layer 11, a substrate 12, a substrate 13, an electrode 14, electrodes 15 (an electrode 15a to an electrode 15g), and spacers 16. The liquid crystal layer 11 contains liquid crystal molecules 11a and is held by the substrate 12 and the substrate 13. The liquid crystal layer 11 is formed thicker than the liquid crystal layer 21 of the display unit 20 in order to form a lens, and has a thickness of about 30 μm. The substrate 12 is, for example, a glass substrate. The substrate 13 is formed from a transmissive material such as glass or resin. Moreover, the substrate 13 has a function as a protective layer for protecting the display device 1. The liquid crystal layer 11 containing the liquid crystal molecules 11a is driven by the electric field generated between the electrode 14 and the electrodes 15. Switching elements such as transistors for controlling at least one of the electrode 14 and the electrode 15 may be provided on the substrate 12 and the substrate 13, respectively, in the same manner as the display unit 20.

Each spacer 16 is a columnar member. The spacers 16 are arranged between the substrate 12 and the substrate 13 in order to maintain the space between the substrate 12 and the substrate 13. Each spacer 16 has a height of about 30 μm the same as the thickness of the liquid crystal layer 11.

The drive circuit 40 drives the liquid crystal unit 10 and the display unit 20 based on the signal transmitted by a control unit 2 of an external device.

### 2. Control of Display Device

### Control When 3D Image Is Displayed

FIG. 4 is a diagram of an example of control when a 3D image is displayed.

When the display unit 20 displays a 3D image, as illustrated in FIG. 4, the drive circuit 40 drives the liquid crystal unit 10 so that the liquid crystal molecules 11a form a lens. Specifically, the drive circuit 40 applies voltages different gradually like 4 V, 2 V, 1.5 V, 0 V, 1.5 V . . . to the electrode 15a, the electrode 15b, the electrode 15c, the electrode 15d, the electrode 15e, . . . respectively.

When the lens is formed in the liquid crystal unit 10 in this manner, light is slightly scattered by the refractive effect of the lens. Therefore, even if the user views the display device 1 from its front side or even if the user obliquely views the display device 1, the spacers 16 are never visible by the user.

### State in Which Voltage Is Not Applied to Electrodes 15 of Liquid Crystal Unit 10

FIG. 5 is a diagram of an example of light transmission when the display device 1 in which a voltage is not applied to the electrodes 15 of the liquid crystal unit 10 is viewed from the front. FIG. 6 is a diagram of an example of light transmission when the display device 1 in which a voltage is not applied to the electrodes 15 of the liquid crystal unit 10 is viewed obliquely. FIG. 7 is a diagram of an example when the display device 1 in which a voltage is not applied to the electrodes 15 of the liquid crystal unit 10 is viewed obliquely.

When a voltage is not applied to the electrodes 15 of the liquid crystal unit 10, the lens is not formed in the liquid crystal unit 10 as illustrated in FIG. 5 and FIG. 6.

In this way, when the user views the display device 1 from the front while the voltage is not applied to the electrodes 15, the spacers 16 are almost invisible from the user because their diameter are small. Even if the display unit 20 displays a 2D image in this state, the light of each pixel is not blocked by the spacers 16 as illustrated in FIG. 5, and therefore the spacers 16 hardly affect the visibility of the 2D image.

On the other hand, when the user views the display device 1 obliquely while the voltage is not applied to the electrodes 15, the spacers 16 become visible from the user as illustrated in FIG. 7 because the spacers 16 have a height of about 30 μm which is comparatively high. When the display unit 20 displays the 2D image in this state, lights of part of the pixels are blocked by the spacers 16 as illustrated in FIG. 6, and this causes the spacers 16 to lower the visibility of the 2D image.

### Control When 2D Image Is Displayed

FIG. 8 is a diagram of an example of control when a 2D image is displayed. FIG. 9 is a diagram of an example when the display device 1 displaying a 2D image is viewed obliquely. As illustrated in FIG. 9, a plain image appears as the 2D image.

When the display unit 20 displays a 2D image, the drive circuit 40 drives the liquid crystal unit 10 so that light scattering components are generated over the entire liquid crystal layer 11 as illustrated in FIG. 8. Specifically, the drive circuit 40 applies substantially fixed voltages, like 1.5 V, 1.5 V, 1.5 V, 1.5 V, 1.5 V . . . , to the electrode 15a, the electrode 15b, the electrode 15c, the electrode 15d, the electrode 15e, respectively.

The substantially fixed voltage is, for example, a voltage in a range of one time to two times of a threshold voltage at which the orientation of the liquid crystal molecules 11a starts changing. The threshold voltage is, for example, 1.0 V to 1.5 V. If the voltage falls within this range, voltages respectively applied to the electrodes 15 may be made different.

When the voltage applied is the substantially fixed voltage, as illustrated in FIG. 8, the orientation of the liquid crystal molecules 11a close to the electrodes 15 changes, but the orientation of the liquid crystal molecules 11a far from the electrodes 15 does not change. This causes the light scattering effect to be slightly produced, and the spacers 16 are hardly visible from the user as illustrated in FIG. 9 even if the user obliquely views the display device 1. Moreover, when a high voltage is applied to the electrode as is the case where the lens is formed, the resolution of the display device 1 may degrade. However, when the voltage is in the range of one time to two times of the threshold voltage, then such degradation of the resolution does not occur.

As illustrated in FIG. 8, the electrodes 15 are preferably formed so that a width R2 of a range where the orientation of the liquid crystal molecules 11a changes due to the application of the substantially fixed voltage is narrower than a width R1 of a sub-pixel. The electrodes 15 are structured in this manner, and this allows slight light scattering effect to be produced with almost no degradation of the visibility of each pixel.

### Operation of Drive Circuit 40

FIG. 10 is a flowchart of an operation of the drive circuit 40 related to the drive of the liquid crystal unit 10. As illustrated in FIG. 10, when the display unit 20 is in a 3D-image display mode (Step S11, 3D), the drive circuit 40 applies voltages to the electrodes 15 of the liquid crystal unit 10 so as to form a lens or a barrier (Step S12). When the display unit 20 is in a 2D-image display mode (Step S11, 2D), the drive circuit 40 applies a substantially fixed voltage to all the electrodes 15 of the liquid crystal unit 10 (Step S13).

### Advantages

As explained above, when displaying a 2D image, the display device 1 applies a substantially fixed voltage to all the electrodes 15 of the liquid crystal unit 10. This causes the display device 1 to slightly produce the light scattering effect, so that the spacers 16 can be almost invisible from the user even if he/she obliquely views the display device 1. Thus, the degradation of the visibility of the display device 1 due to the presence of the spacers 16 can be reduced.

### 3. Application Examples (Electronic Apparatuses)

Examples of applying the display device 1 to electronic apparatuses will be explained below.

As application examples according to the present disclosure, the examples of applying the display device 1 to electronic apparatuses are explained below.

FIG. 11 to FIG. 23 are diagrams of examples of an electronic apparatus with the display device 1 according to the embodiment. The display device 1 can be applied to electronic apparatuses in every field such as television devices, digital cameras, notebook personal computers, portable electronic apparatuses such as a mobile telephone, or video cameras. In other words, the display device 1 can be applied to electronic apparatuses in every field which display an externally input video signal or an internally generated video signal as an image or a video.

### Application Example 1

The electronic apparatus illustrated in FIG. 11 is a television device to which the display device 1 is applied. Examples of the television device include, but are not limited to, a video display screen unit 510 including a front panel 511 and a filter glass 512, and the display device 1 is applied to the video display screen unit 510. In other words, the screen of the television device may have a function of detecting a touch operation in addition to a function of displaying images.

### Application Example 2

The electronic apparatus illustrated in FIG. 12 and FIG. 13 is a digital camera to which the display device 1 is applied. Examples of the digital camera include, but are not limited to, a light emitting unit 521 for a flash, a display unit 522, a menu switch 523, a shutter button 524, and a lens cover 525, and the display device 1 is applied to the display unit 522. Therefore, the display unit 522 of the digital camera may have a function of detecting a touch operation in addition to a function of displaying images.

### Application Example 3

The electronic apparatus illustrated in FIG. 14 represents an appearance of a video camera to which the display device 1 is applied. Examples of the video camera include, but are not limited to, a main body 531, a lens 532 for photographing a subject provided on the front side face of the main body 531, a start/stop switch 533 in photographing, and a display unit 534. The display device 1 is applied to the display unit 534. Therefore, the display unit 534 of the video camera may have a function of detecting a touch operation in addition to a function of displaying images.

### Application Example 4

The electronic apparatus illustrated in FIG. 15 is a notebook personal computer to which the display device 1 is applied. Examples of the notebook personal computer include, but are not limited to, a main body 541, a keyboard 542 for performing an input operation of text and the like, and a display unit 543 for displaying an image. The display device 1 is applied to the display unit 543. Therefore, the display unit 543 of the notebook personal computer may have a function of detecting a touch operation in addition to a function of displaying images.

### Application Example 5

The electronic apparatus illustrated in FIG. 16 to FIG. 22 is a mobile phone to which the display device 1 is applied. FIG. 16 is a front view of the mobile phone in its opened state, FIG. 17 is a right side view of the mobile phone in the opened state, FIG. 18 is a front view of the mobile phone in its folded state, FIG. 19 is a left side view of the mobile phone in the folded state, FIG. 20 is a right side view of the mobile phone in the folded state, FIG. 21 is a top view of the mobile phone in the folded state, and FIG. 22 is a bottom view of the mobile phone in the folded state. The mobile phone is the one that has, for example, an upper housing 551 and a lower housing 552 connected to each other with a connection (hinge portion) 553, and that includes a display 554, a sub-display 555, a picture light 556, and a camera 557. The display device 1 is mounted on the display 554. Therefore, the display 554 of the mobile phone may have a function of detecting a touch operation in addition to a function of displaying images.

### Application Example 6

The electronic apparatus illustrated in FIG. 23 is a portable information terminal that operates as a portable computer, a multifunctional mobile phone, a portable computer capable of performing voice communication, or as a portable computer capable of performing communication, and that is sometimes referred to as so-called a smartphone or a tablet terminal. The portable information terminal has a display unit 562 on the surface of, for example, a housing 561. The display device 1 is mounted on the display unit 562. The display unit 562 may have a function of detecting a touch operation in addition to a function of displaying images.

### 4. Aspects of the Present Disclosure

The present disclosure includes the following aspects.
(1) A display device comprising:

a display unit that displays either one of a two-dimensional image and a three-dimensional image;

a liquid crystal unit that includes a plurality of electrodes used to drive a liquid crystal layer and is placed over the display unit; and

a drive circuit that applies, when the display unit displays the three-dimensional image, voltages to the electrodes so that the liquid crystal layer forms either one of a lens and a barrier, and applies, when the display unit displays the two-dimensional image, a substantially fixed voltage to the electrodes.
(2) The display device according to (1), wherein the substantially fixed voltage is a voltage in a range of one time to two times of a threshold voltage at which orientation of liquid crystal molecules in the liquid crystal layer starts changing.
(3) The display device according to (1), wherein a width of a range where orientation of liquid crystal molecules in the liquid crystal layer changes due to the application of the substantially fixed voltage is narrower than a width of a sub-pixel on the display unit.
(4) The display device according to (1), further comprising:

a pair of substrates for holding the liquid crystal layer; and

a spacer for maintaining a space between the pair of substrates.
(5) An electronic apparatus comprising:

a display unit that displays either one of a two-dimensional image and a three-dimensional image;

a liquid crystal unit that includes a plurality of electrodes used to drive a liquid crystal layer and is placed over the display unit; and

drive circuit that applies, when the display unit displays the three-dimensional image, voltages to the electrodes so that the liquid crystal layer forms either one of a lens and a barrier, and applies, when the display unit displays the two-dimensional image, a substantially fixed voltage to the electrodes.

According to the present disclosure, it is possible to provide the display device and the electronic apparatus capable of reducing the degradation of the visibility due to the presence of spacers.

What is claimed is:

1. A display device comprising:
a display unit that displays either one of a two-dimensional image and a three-dimensional image;
a liquid crystal unit that includes a plurality of electrodes used to drive a liquid crystal layer and is placed over the display unit; and
a drive circuit that applies, when the display unit displays the three-dimensional image, voltages to the electrodes so that the liquid crystal layer forms either one of a lens and a barrier, and applies, when the display unit displays the two-dimensional image, a substantially fixed voltage to the electrodes.

2. The display device according to claim 1, wherein the substantially fixed voltage is a voltage in a range of one time to two times of a threshold voltage at which orientation of liquid crystal molecules in the liquid crystal layer starts changing.

3. The display device according to claim 1, wherein a width of a range where orientation of liquid crystal molecules in the liquid crystal layer changes due to the application of the substantially fixed voltage is narrower than a width of a sub-pixel on the display unit.

4. The display device according to claim 1, further comprising:
a pair of substrates for holding the liquid crystal layer; and
a spacer for maintaining a space between the pair of substrates.

5. An electronic apparatus comprising:
a display unit that displays either one of a two-dimensional image and a three-dimensional image;
a liquid crystal unit that includes a plurality of electrodes used to drive a liquid crystal layer and is placed over the display unit; and
a drive circuit that applies, when the display unit displays the three-dimensional image, voltages to the electrodes so that the liquid crystal layer forms either one of a lens and a barrier, and applies, when the display unit displays the two-dimensional image, a substantially fixed voltage to the electrodes.
